(19) United States
(12) Patent Application Publication
(10) Pub. No.: US 2017/0098182 A1
(43) Pub. Date: Apr. 6, 2017

(54) OPERATOR PERFORMANCE MONITORING SYSTEM

(71) Applicant: Caterpillar Inc., Peoria, IL (US)

(72) Inventors: Ryan Joseph La Reau, East Peoria, IL (US); Joshua CC. Edwards, Washington, IL (US); Beth Ladd, Seymour, IL (US); David James Edwards, Dunlap, IL (US); Yong Li, Peoria, IL (US); Juju Ratna Manandhar, Champaign, IL (US); Gerald W. Edwards, JR., St. John, IN (US)

(73) Assignee: Caterpillar Inc., Peoria, IL (US)

(21) Appl. No.: 15/386,776

(22) Filed: Dec. 21, 2016

(51) Int. Cl. G06Q 10/06

(52) U.S. Cl. CPC G06Q 10/06395

(57) ABSTRACT

A performance monitoring system associated with a machine is provided. The system includes a sensor assembly configured to generate data of one or more parameters associated with an operation of the machine. The system further includes a controller communicably coupled to the sensor assembly. The controller is configured to determine a list of performance parameters associated with a performance of an operator while operating the machine. The controller selects a set of performance parameters from the list of performance parameters. The controller receives the data associated with the set of performance parameters from the sensor assembly. The controller compares the data associated with the set of performance parameters with respective predetermined thresholds. The controller evaluates the performance of the operator based on the comparison. Also, the controller displays a visual cue to the operator. The visual cue is indicative of the performance of the operator based on the evaluation.

### TECHNICAL FIELD

The present disclosure relates to a monitoring system, and more particularly to a system for monitoring a performance of an operator using a machine.

### BACKGROUND

Construction and mining machines, for example, a wheel loader, a mining truck, and other machines, include an implement to perform a variety of tasks on a worksite. An operator who operates these machines may need to acquire certain skills or training over a period of time to efficiently operate the machine in order to perform the desired tasks at the worksite. In order for the operator to understand his strengths and weaknesses in operating the machine, the operator may need to be given periodic feedback so that the operator may be coached correctly and adequately based on his customized needs of improvement.

Generally, a performance of an operator may be manually evaluated by his supervisor. In case of large fleets of machines operating at the worksite, it may be difficult for the supervisor to individually monitor the performance of each operator. Also, some supervisors may be stricter than others, making it difficult to have a standardized approach to evaluating the performance of the operator. Further, the manual approach to providing feedback is based on the subjective opinion of the supervisor, making it cumbersome to effectively track progress of the operator in operating different types of machines.

U.S. Pat. No. 7,257,513 describes a system and method for monitoring performance of at least one machine operator, the system comprising at least one measuring device for measuring at least one machine parameter during operation of the machine by the operator, a server for generating at least one performance indicator distribution from measurements of the at least one machine parameter and a performance indicator calculation module for calculating at least one performance indicator from the at least one performance indicator distribution. Feedback may be provided to the operator by displaying the at least one performance indicator in substantially real-time to the operator on display module onboard the machine.

### SUMMARY OF THE DISCLOSURE

In one aspect of the present disclosure, a performance monitoring system associated with a machine is provided. The system includes a sensor assembly associated with the machine. The sensor assembly is configured to generate data of one or more parameters associated with an operation of the machine. The system further includes a controller communicably coupled to the sensor assembly. The controller is configured to determine a list of performance parameters associated with a performance of an operator while operating the machine. The controller is configured to select a set of performance parameters from the list of performance parameters. The controller is configured to receive the data associated with the set of performance parameters from the sensor assembly. The controller is configured to compare the data associated with the set of performance parameters with respective predetermined thresholds. The controller is configured to evaluate the performance of the operator based on the comparison. Also, the controller is configured to display a visual cue to the operator. The visual cue is indicative of the performance of the operator based on the evaluation.

Other features and aspects of this disclosure will be apparent from the following description and the accompanying drawings.

### BRIEF DESCRIPTION OF THE DRAWINGS

FIG. 1 is a perspective view of an exemplary machine, according to various concepts of the present disclosure;

FIG. 2 is a block diagram of a performance monitoring system, according to various concepts of the present disclosure; and

FIGS. 3 to 6 are schematics of exemplary visual cues provided by the performance monitoring system, according to various concepts of the present disclosure.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

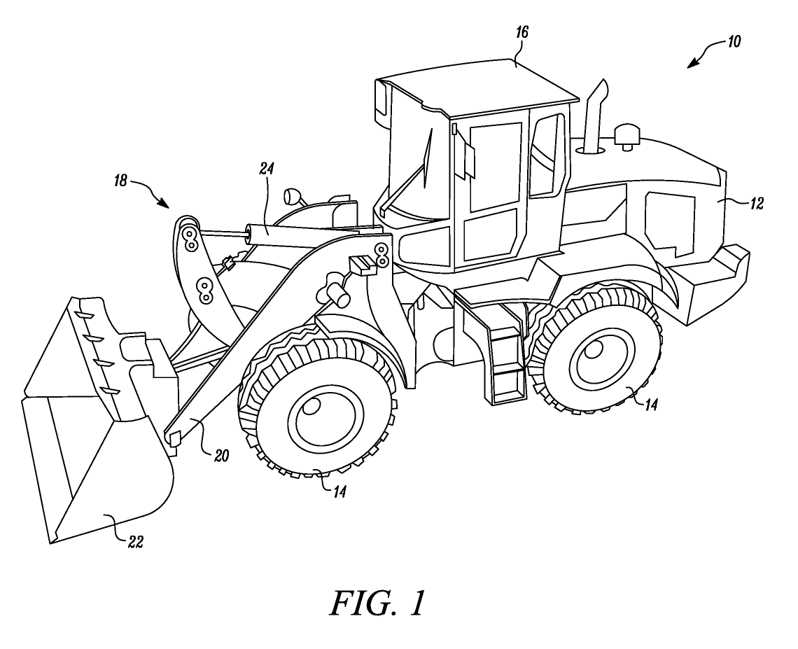

FIG. 1 represents an exemplary machine 10, according to one embodiment of the present disclosure. More specifically, the machine 10 is embodied as a wheel loader. Alternatively, the machine 10 may include any other machine used in the construction or mining industry such as a motor grader, an excavator, a wheel tractor scraper, a mining truck, and so on.

Referring to FIG. 1, the machine 10 includes a frame 12. A powertrain and/or a drivetrain (not shown) is also provided on the machine 10 for the production and transmission of motive power. The powertrain includes a power source (not shown) and is located within an enclosure of the machine 10. The power source may include one or more engines or other power delivery systems such as batteries, hybrid engines, and the like.

The machine 10 also includes wheels 14 for the purpose of mobility. The powertrain may also include a torque converter, a transmission system inclusive of gearing, a drive shaft and other known drive links provided between the power source and the wheels 14 for the transmission of the motive power. Further, the machine 10 has an operator cabin 16 that houses controls for operating the machine 10.

As shown in FIG. 1, a linkage assembly 18 is attached to the frame 12 of the machine 10. The linkage assembly 18 includes a lift arm 20. An implement, such as a bucket 22, is pivotally coupled to the lift arm 20. It may be noted that the linkage assembly 18 and the implement of the machine 10 may vary based on the type of machine 10 or the type of operation or task required to be carried out by the machine 10.

During operation of the machine 10, the lift arm 20 and the bucket 22 may be moved to different positions in order to perform excavation and dumping tasks. The movement of the lift arm 20 and/or the bucket 22 is controlled by hydraulic and/or pneumatic cylinders 24, which are coupled to these parts. Accordingly, based on the movement of the lift arm 20 and the bucket 22, the machine 10 may perform different operations such as excavating, loading, and dumping.

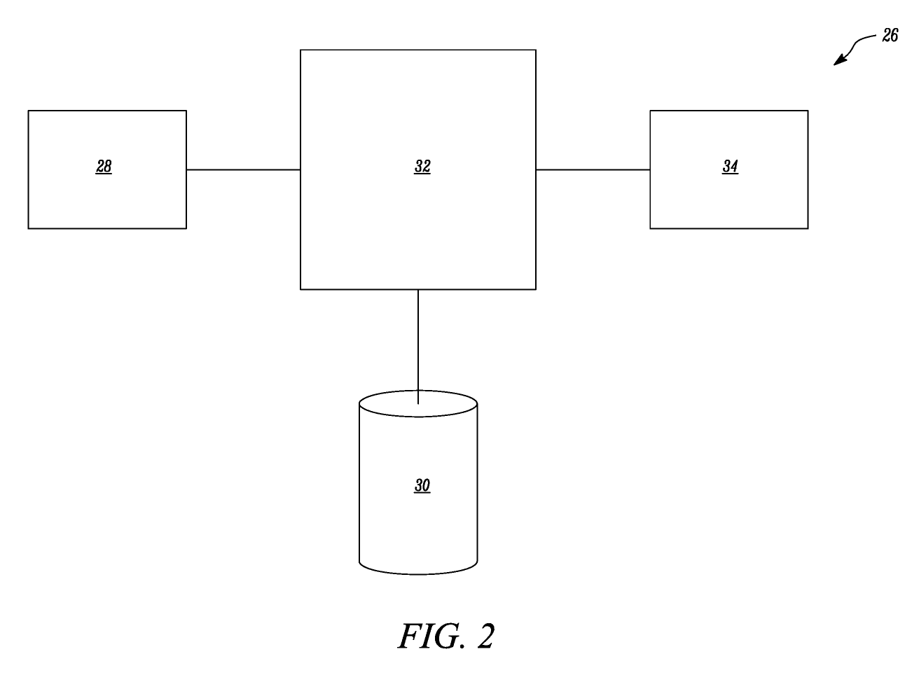

The present disclosure relates to a performance monitoring system 26 associated with the machine 10. Referring to FIG. 2, the performance monitoring system 26 includes a sensor assembly 28 associated with the machine 10. The sensor assembly 28 may include various sensors or signal processing modules that are positioned at different locations on the machine 10 for receiving and processing sensory data associated with one or more parameters related to operating the machine 10. The one or more parameters may include, but not limited to, machine speed, engine speed, fuel usage, and so on.

The one or more parameters may be associated with corresponding performance parameters or key performance indicators (KPIs) which may be predefined in order to monitor and track a performance of an operator who is operating the machine 10. In some embodiments, the performance parameters may broadly belong to the following categories: performance, safety, machine health, and sustainability, irrespective of a type of the machine 10. Further, the performance parameters that may be defined under each of these categories may vary based on the type of the machine. For example, in case of the wheel loader, the performance parameters may be defined based on a number of activities associated with the wheel loader including, but not limited to, drop bucket operation, impact material, lift and curl operations, wheel rotations, and dump operations. Accordingly, for this machine 10, exemplary performance parameters may include load proximity, bucket fill time, number of wheel turns, payload production, load time, and number of pass matches, and so on.

In another example, in case of an off-highway truck, the activities associated with the given machine may include, but not limited, drive to dump site, spot truck, dumping material, raising dump body, return to load site, and so on. Accordingly, exemplary performance parameters may include, but not limited to, drive time, queue time, spotting time, dump time, haul time, raise time, and return time. Also, performance parameters associated with the sustainability of the machine may include, for example, fuel usage and carbon emissions. Exemplary machine health performance parameters may include tire usage, over speed usage, tire heat, lane position or drift, retarder usage, and so on. Further, performance parameters belonging to the safety category may include, for example, machine fault codes, location or obstacle detection information or near misses, operator field of vision data, and so on. The performance parameters described herein are exemplary and do not limit the scope of the present disclosure. This list of performance parameters may be predefined for different types of the machines and stored in a database 30 associated with the system. The database 30 may include any internal or external data source or data repository, cloud or other type of information storage system that may be accessed to retrieve relevant data therefrom.

Further, the performance monitoring system 26 includes a controller 32 that is communicably coupled to the database 30 and the sensor assembly 28. The controller 32 is configured to access the database 30 and determine the list of performance parameters that may be further utilized to evaluate the performance of the operator. The controller 32 selects a set of performance parameters from the list of performance parameters. In one embodiment, the selection of the set of performance parameters may be based on the type of the machine 10. For example, in case of the wheel loader, the controller 32 may select the set of performance parameters such as, payload per pass, load time per pass, torque converter overheat, fuel efficiency, near misses, and so on that are pre-defined by the system in order to evaluate the performance of the operator operating the machine 10 based on the type of machine 10. Alternatively, in other embodiments, the operator may provide an input and select the performance parameters against which the system will evaluate his performance. For example, the operator may provide the input indicating that he wishes to be evaluated on certain dump or load operation parameters that are predefined in the system.

The controller 32 may retrieve the data associated with the selected performance parameters from the sensor assembly 28. After the selection of the set of performance parameters from the list of performance parameters, the controller 32 may only retrieve the sensory data from the sensor assembly 28 that are relevant for evaluating the performance of the operator with respect to the selected performance parameters. The sensory data may be received on a real-time basis by the controller 32. In other embodiments, the sensory data may be stored in the database 30 for later retrieval of the sensory data by the controller 32 from the database 30. Alternatively, this data may be obtained from performance reports or logs.

The controller 32 may then compare the data received from the sensor assembly 28 with respective predetermined thresholds. These predetermined thresholds or baseline key performance indicator values may be pre-stored and retrieved by the controller 32 from the database 30. The predetermined thresholds may be established based on historical machine operation data associated with a customizable machine population, for example, the machine population may include historical data associated with operation of a given machine by different operators, historical data associated with a machine fleet, or historical data associated with a group of machine fleets. These predetermined thresholds may be based on performance information that may be gathered and standardized over time including information associated with performance of a number of operators having distinct levels of experience in handling different types of the machines 10.

The analysis conducted by the controller 32 to evaluate the performance of the operator may vary based on the performance parameter being evaluated. For example, in case of the machine fault codes performance parameter, the controller 32 may assess records of the machine fault codes that are logged as the operator performs desired tasks using the machine 10. While evaluating the performance of the operator with respect to this performance parameter, the controller 32 may attribute a higher performance score to the operator who has logged none or few machine fault codes as compared to the operator who has logged a number of the machine fault codes while operating the machine 10. This analysis may differ for different performance parameters and may be appropriately predefined by the system.

The controller 32 may then evaluate the performance of the operator based on the comparison of the data with the respective predetermined thresholds. For example, based on the comparison, the controller 32 may evaluate if the operator is handling the machine appropriately, the controller 32 may evaluate an experience level of the operator, and/or the controller 32 may ascertain strengths and weaknesses of the operator's performance. Further, the controller 32 may also track or monitor a change in performance of the operator based on his past records. In some embodiments, the controller 32 may compute a performance score based on a mathematical equation, formula, or relation that is predefined in the system.

The controller 32 may also assign weighting factors to the set of performance parameters based on customer business goals. Accordingly, the evaluation of the performance of the operator may be an absolute score such that the operator may review his previous scores and track his individual performance over time. Alternatively, the score provided by the controller 32 may be a relative score based on a similar assessment of the performance of other operators operating the same machine or other machines over time. The evaluation of the performance of the operator may be conducted on a real-time basis as the operator is performing various tasks on the machine 10. Alternatively, the evaluation of the performance of the operator may be conducted after the tasks have been completed by operator, considering the performance data that is stored in the database 30.

The controller 32 may also be coupled to an output unit 34. The output unit 34 may include any visual display unit, for example, a screen, a monitor, or other known display. In some examples, the output unit 34 may include a display provided on a dashboard present within the operator cabin 16 of the machine 10. Alternatively, the output unit 34 may include a screen or display of a personal computing device, such as a laptop, a netbook, a smartphone, an augmented reality headset, and other such devices through which the user may log into his profile and view his performance data or history.

The visual cue may be displayed in the form of a performance badge based on the evaluation of the operator's performance. The visual cue is an icon or group of icons that may be displayed to the operator by the controller 32 via the output unit 34 in order to provide the operator with feedback on his performance of operating the machine 10. The display of these visual cues facilitates gamification of operator performance in which game-like elements, such as badges, may be provided to the operator to represent an accomplishment of the operator in an action, task, or function associated with operating the machine 10.

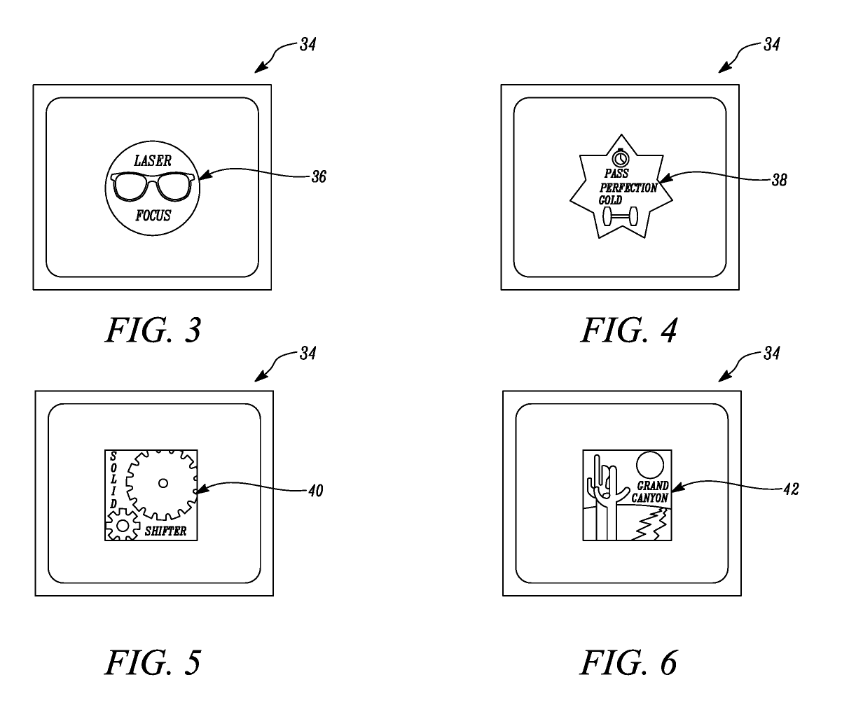

The visual cue may be indicative of the successes and accomplishments of the operator and may be used to reward the operator for his efforts and good work. Referring to FIGS. 3 to 6, exemplary badges 36, 38, 40, 42 are illustrated. Each of these badges 36, 38, 40, 42 may be displayed to the operator on a display of the output unit 34.

For example, referring to FIG. 3, the badge 36 may be displayed to the operator if the wheel loader being operated by the operator has an average between 0 and 1 near misses per shift for 10 shifts. Referring to FIG. 4, the badge 38 may be displayed on the display of the output unit 34 if the operator completes 50 passes with more than 2.3 tons and at a rate faster than 35 seconds. Referring to FIG. 5, the badge 40 may be displayed on the output unit 34 if the operator has operated the machine 10 such that the machine 10 has an average of less than 1 torque converter overheat per shift for 10 shifts. Further, referring to FIG. 6, the badge 42 may be displayed to the operator if operator has operated the machine 10 such that average fuel burn in the machine 10 is less than 26 gals/hour for 10 shifts.

A person of ordinary skill in the art will appreciate that the badges 36, 38, 40, 42 shown in the accompanying figures are exemplary and do not limit the scope of the present disclosure. Further, the values described above in connection with the exemplary scenarios are merely on an illustrative basis and may vary based on the system requirements. The appearance of the badges 36, 38, 40, 42 may change and is not limited to that disclosed herein. Further, there may be various other such similar situations that are not described herein for which the operator may be awarded similar badges. Based on the performance of the operator, the operator may be awarded one or more such badges. Further, the number of badges for each operator may be stored by the controller 32 in the database 30 to build on an existent profile of the operator for later retrieval or further building of the profile of the operator.

The controller 32 may embody a single microprocessor or multiple microprocessors. Numerous commercially available microprocessors can be configured to perform the functions of the controller 32. The controller 32 may include all the components required to run an application such as, for example, a memory, a secondary storage device, and a processor, such as a central processing unit or any other means known in the art. Various other known circuits may be associated with the controller 32, including power supply circuitry, signal-conditioning circuitry, solenoid driver circuitry, communication circuitry, and other appropriate circuitry.

### INDUSTRIAL APPLICABILITY

The present disclosure provides an objective methodology and system for evaluating the performance of the operator. The system user access and editing rights may be controlled by a system administrator such that the system administrator may override certain performance parameters with respect to scoring criteria including changes to the weighting factors for the evaluation of the performance of the operator.

Further, the system provides visual feedback to the operator and rewards the operator for his good work, thereby encouraging and motivating the operator to perform well. The gamification functionality may be easily integrated into the system. For individual operators, the system may assist in achieving milestones, improving self-performance through the badges. The operator may be able to track his performance such that the system may allow the operator to level up his experience with his accomplishment points obtained through the evaluation of his performance. This may also encourage the operators to stand out from the crowd and be noticed in the relevant operator community through the accumulation of badges and high evaluation scores.

For the supervisor of the worksite, the system may provide useful data and insights indicative of the overview of the operator skills, such that the supervisor is easily made aware of the strengths and weaknesses of individual operators. This micro-level implementation of the performance monitoring system 26 may assist in obtaining macro-level results in which the supervisor may be able to easily and objectively identify any fluctuations and inefficiencies through the constant monitoring and tracking of individual operator performances for overall increase in production and efficiency of the system.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof

What is claimed is:

1. A performance monitoring system associated with a machine, the performance monitoring system comprising:
a sensor assembly associated with the machine, the sensor assembly configured to generate data of one or more parameters associated with an operation of the machine; and
a controller communicably coupled to the sensor assembly, the controller configured to:
determine a list of performance parameters associated with a performance of an operator while operating the machine;
select a set of performance parameters from the list of performance parameters;
receive the data associated with the set of performance parameters from the sensor assembly;
compare the data associated with the set of performance parameters with respective predetermined thresholds;
evaluate the performance of the operator based on the comparison; and
display a visual cue to the operator, wherein the visual cue is indicative of the performance of the operator based on the evaluation.
